(19) United States
(12) Patent Application Publication
(10) Pub. No.: US 2020/0301637 A1
(43) Pub. Date: Sep. 24, 2020

(54) MANAGEMENT SYSTEM

(71) Applicant: KYOCERA Document Solutions Inc., Osaka-shi (JP)

(72) Inventor: Takeshi ARAYA, Osaka-shi (JP)

(21) Appl. No.: 16/814,005

(22) Filed: Mar. 10, 2020

(30) Foreign Application Priority Data
Mar. 22, 2019 (JP) 2019-054254

(51) Int. Cl. G06F 3/12; H04N 1/32

(52) U.S. Cl. CPC G06F 3/1262; H04N 1/3208; G06F 3/1217; G06F 3/1296

(57) ABSTRACT

A server of a management system queues a schedule when an enqueue condition for queuing the schedule for transmitting counter information collected from an image forming apparatus is satisfied, and dequeues and executes the schedule when a dequeue condition for dequeuing the schedule is satisfied.

### INCORPORATION BY REFERENCE

This application is based upon, and claims the benefit of priority from, corresponding Japanese Patent Application No. 2019-054254 filed in the Japan Patent Office on Mar. 22, 2019, the entire contents of which are incorporated herein by reference.

### BACKGROUND

### Field of the Invention

The present disclosure relates to a management system for managing an electronic apparatus.

### Description of Related Art

Conventionally, as a management system for managing an electronic apparatus, there has been known a management system which collects counter information indicating the number of sheets printed by a printer of an image forming apparatus.

### SUMMARY

A management system of the present disclosure includes a server for executing a schedule for transmitting information collected from an electronic device, the server subjects the schedule to a queuing when an enqueue condition for subjecting the schedule to the queuing is satisfied, and the server subjects the schedule to a dequeuing to execute the schedule when a dequeue condition for subjecting the schedule to the dequeuing is satisfied.

### BRIEF DESCRIPTION OF THE DRAWINGS

FIG. 1 is a block diagram of a system according to a first embodiment of the present disclosure;

FIG. 2 is a block diagram of an image forming apparatus shown in FIG. 1 in the case of a multifunction peripheral (MFP);

FIG. 3 is a diagram showing a part of an example of the operation of the system shown in FIG. 1 when the processing of schedules S1, S2, S3 and S4 is successfully executed;

FIG. 4 is a diagram showing an example of an operation subsequent to the operation shown in FIG. 3;

FIG. 5 is a diagram showing an example of the operation of the system shown in FIG. 1 when an error occurs during the execution of the processing of the schedules S1, S2, S3 and S4;

FIG. 6 is a diagram showing an example of the operation of the system shown in FIG. 1 when queuing a schedule in a server in a management system;

FIG. 7 is a diagram showing an example of the operation of the system shown in FIG. 1 when dequeuing a schedule from a server in the management system;

FIG. 8 is a block diagram of a system according to a second embodiment of the present disclosure;

FIG. 9 is a diagram showing an example of the operation of the system shown in FIG. 8 when a server in the management system stores an execution error history of a schedule in error history information;

FIG. 10 is a diagram showing an example of the error history information shown in FIG. 8;

FIG. 11 is a diagram showing an example of the operation of the system shown in FIG. 8 when queuing a schedule in a server in the management system;

FIG. 12 is a diagram showing an example of the operation of the system shown in FIG. 8 when dequeuing a schedule from a server in the management system;

FIG. 13 is a diagram showing an example of the operation of the system shown in FIG. 8 when a server in the management system executes a schedule after confirming the error history information;

FIG. 14 is a diagram showing an example of the operation of the system shown in FIG. 8, which is different from the example shown in FIG. 13, when a server in the management system executes a schedule after confirming the error history information;

FIG. 15 is a block diagram of a system according to a third embodiment of the present disclosure;

FIG. 16 is a diagram showing an example of the operation of the system shown in FIG. 15 when a server in the management system stores an execution result of a schedule in execution result information;

FIG. 17 is a diagram showing an example of the execution result information shown in FIG. 15;

FIG. 18 is a diagram showing an example of the operation of the system shown in FIG. 15 when queuing a schedule in a server in the management system;

FIG. 19 is a diagram showing an example of the operation of the system shown in FIG. 15 when dequeuing a schedule from a server in the management system;

FIG. 20 is a block diagram of a system according to a fourth embodiment of the present disclosure;

FIG. 21 is a diagram showing an example of the operation of the system shown in FIG. 20 when storing aggregate data of schedule execution results in aggregate data information by a server in a management system;

FIG. 22 is a diagram showing an example of the aggregate data information shown in FIG. 20;

FIG. 23 is a diagram showing an example of the operation of the system shown in FIG. 20 when queuing a schedule in a server in the management system;

FIG. 24 is a diagram showing an example of the operation of the system shown in FIG. 20 when dequeuing a schedule from a server in the management system; and

FIG. 25 is a block diagram of a system according to a fifth embodiment of the present disclosure.

### DETAILED DESCRIPTION

Hereinafter, embodiments of the present disclosure will be described with reference to the drawings.

### First Embodiment

First, the configuration of a system according to a first embodiment of the present disclosure will be described.

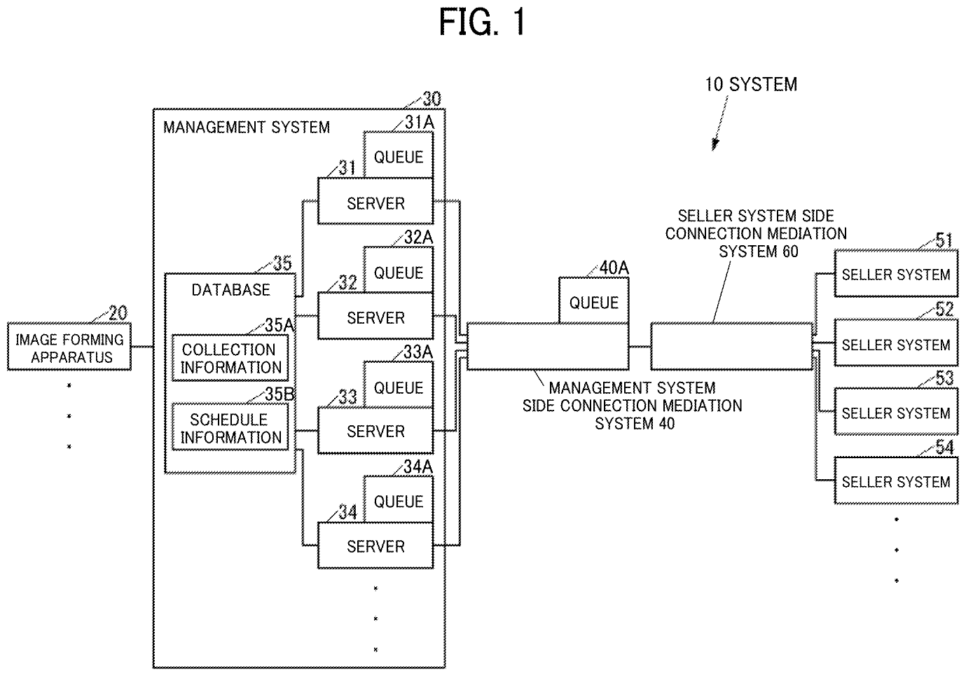

FIG. 1 is a block diagram of a system 10 according to the present embodiment.

As shown in FIG. 1, the system 10 includes an image forming apparatus 20 as an electronic apparatus. The image forming apparatus 20 is configured by, for example, a multifunction peripheral (MFP), a printer dedicated machine, a copying dedicated machine, and the like. In addition to the image forming apparatus 20, the system 10 may include at least one image forming apparatus similar to the image forming apparatus 20. The image forming apparatus in the system 10 is held by the owner of the image forming apparatus itself, not by the manufacturer of the image forming apparatus itself.

The system 10 includes a management system 30 for managing the image forming apparatus in the system 10. The management system 30 may be configured by a single computer or a plurality of computers. The management system 30 may also be a system that operates on a cloud. The management system 30 is operated by the manufacturer of the image forming apparatus. A user can access the management system 30 via a web browser, obtain the status and history information of an arbitrary image forming apparatus from the management system 30, and perform maintenance of the arbitrary image forming apparatus via the management system 30. In addition, the management system 30 can notify a specific notification destination when a problem occurs in the image forming apparatus or when the remaining amount of consumables in the image forming apparatus becomes equal to or smaller than a specific amount.

The system 10 includes a management system side connection mediation system 40 which functions as a hub for connecting the management system 30 to the other system. The management system side connection mediation system 40 may be configured by a single computer or a plurality of computers. The management system side connection mediation system 40 may also be a system that operates on a cloud. The management system side connection mediation system 40 is operated by the manufacturer of the image forming apparatus.

The system 10 includes a seller system 51 operated by a seller such as a sales company and a dealer of the image forming apparatus. The seller system 51 may be configured by a single computer or a plurality of computers. The seller system 51 may also be a system that operates on a cloud. The system 10 includes a plurality of seller systems each similar to the seller system 51, such as a seller system 52, a seller system 53, and a seller system 54. The seller system is operated for each seller. For example, the seller system can acquire counter information indicating the number of sheets printed by the printer of the image forming apparatus from the management system 30, generate an invoice for the invoice amount based on the counter information, and transmit the invoice to the owner of the image forming apparatus.

The system 10 includes a seller system side connection mediation system 60 which functions as a hub for connecting the seller system to the other system. The seller system side connection mediation system 60 may be configured by a single computer or a plurality of computers. The seller system side connection mediation system 60 may also be a system that operates on a cloud.

The image forming apparatus and the management system 30 in the system 10 can communicate with each other via a network such as the Internet.

The management system 30 and the management system side connection mediation system 40 can communicate with each other via a network such as a local area network (LAN) or the Internet or directly via a wired or wireless connection without use of a network.

The management system side connection mediation system 40 and the seller system side connection mediation system 60 can communicate with each other via a network such as the Internet.

The seller system side connection mediation system 60 and the seller system can communicate with each other via a network such as the Internet.

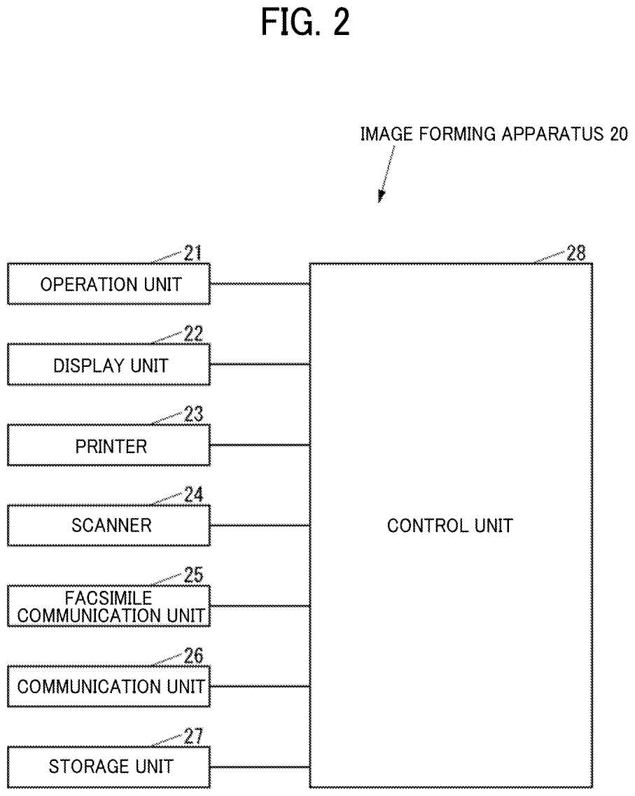

FIG. 2 is a block diagram of the image forming apparatus 20 in the case of the MFP.

As shown in FIG. 2, the image forming apparatus 20 includes an operation unit 21 that is an input device such as a button for inputting various operations, a display unit 22 that is a display device such as a liquid crystal display (LCD) for displaying various information, a printer 23 that is a printing device for printing an image on a recording medium such as paper, and a scanner 24 that is a reading device for reading an image from a document. The image forming apparatus 20 further includes a facsimile communication unit 25 that is a facsimile device for performing facsimile communication with an external facsimile apparatus not shown via a communication line such as a public telephone line, and a communication unit 26 that is a communication device for communicating with an external device via a network such as a LAN or the Internet, or directly via a wired or wireless connection without use of a network. The image forming apparatus 20 further includes a storage unit 27 that is a non-volatile storage device such as a semiconductor memory or a hard disk drive (HDD) for storing various types of information, and a control unit 28 that controls the entire image forming apparatus 20.

The control unit 28 includes, for example, a central processing unit (CPU), a read only memory (ROM) storing a program and various data, and a random access memory (RAM), that is a memory as a volatile storage device used as a work area for the CPU in the control unit 28. The CPU in the control unit 28 executes a program stored in the storage unit 27 or the ROM in the control unit 28.

The control unit 28 executes a program stored in the storage unit 27 or the ROM in the control unit 28 to transmit to the management system 30 various types of information of the image forming apparatus 20 such as counter information indicating the number of sheets printed by the printer 23 and toner information as information relating to the toner including the remaining amount of toner in the printer 23, at specific timing. Note that the timing at which the control unit 28 transmits the various types of information of the image forming apparatus 20 to the management system 30 is a timing that is more frequent than the timing at which the schedule described later is executed.

As shown in FIG. 1, the management system 30 includes a plurality of servers such as a server 31, a server 32, a server 33, and a server 34. Each of the servers in the management system 30 executes a schedule for transmitting the information collected from the image forming apparatus in the system 10 to the seller system at a specific timing.

The schedule includes a plurality of schedules such as schedule S1, schedule S2, schedule S3, and schedule S4.

Each schedule is set to transmit information collected from any image forming apparatus to any seller system at any timing. For example, the schedule S1 is a schedule for transmitting counter information of an image forming apparatus A, an image forming apparatus B, and an image forming apparatus C to the seller system 51 at a specific timing. The schedule S2 is a schedule for transmitting counter information of an image forming apparatus D to the seller system 52 at a specific timing. The schedule S3 is a schedule for transmitting counter information of an image forming apparatus E to the seller system 53 at a specific timing. The schedule S4 is a schedule for transmitting counter information of an image forming apparatus F and an image forming apparatus G to the seller system 54 at a specific timing.

Various timings may be set as the timing at which each schedule is executed. For example, the timing at which each schedule is executed may be a daily timing such as 17:00 every day. The timing may also be a weekly timing such as a specific day of the week. The timing may also be a monthly timing such as a specific day of every month, for example, the 20th of every month, and a specific day of a specific week of every month, for example, the third Wednesday of every month.

Each schedule is assigned to a predetermined server. For example, the schedule S1 is executed by the server 31, the schedule S2 is executed by the server 32, the schedule S3 is executed by the server 33, and the schedule S4 is executed by the server 34.

The server 31 includes a queue 31a for holding a schedule. Similarly, each server in the management system 30 includes a queue. For example, the server 32, the server 33, and the server 34 include a queue 32a, a queue 33a, and a queue 34a, respectively.

The management system 30 includes a database 35 that stores collection information 35a indicating various information collected from the image forming apparatus and schedule information 35b for managing a schedule by the server in the management system 30.

Each time information such as the counter information is transmitted from the image forming apparatus, the management system 30 accumulates the information such as the counter information transmitted from the image forming apparatus in the collection information 35a.

The server in the management system 30 writes the state of the schedule to be processed by the server itself in the schedule information 35b. For example, when the schedule is being executed, the server in the management system 30 writes the status of the schedule being executed as “executing” in the schedule information 35b, and when the execution of the schedule is completed, the server in the management system 30 writes the state of the schedule being executed as “execution completed” in the schedule information 35b.

The management system side connection mediation system 40 includes a queue 40a for holding processes to be executed by the management system side connection mediation system 40. The management system side connection mediation system 40 communicates with the management system 30 by a representational state transfer (REST), and communicates with the seller system side connection mediation system 60 by a simple object access protocol (SOAP). Each of an application program interface (API) for transmitting the counter information from the management system 30 to the management system side connection mediation system 40, and an API for transmitting the counter information from the management system side connection mediation system 40 to the seller system side connection mediation system 60 is configured with a specification that needs to be called for each image forming apparatus that is the target of the counter information. Further, as the number of the counter information simultaneously transmitted from the management system side connection mediation system 40 to the seller system side connection mediation system 60 increases, the possibility of processing errors in the seller system side connection mediation system 60 or the seller system increases. Therefore, the processing of transmitting the counter information from the management system side connection mediation system 40 to the seller system side connection mediation system 60 is based on a specification that limits the maximum number of parallel processes

Next, the operation of the system 10 will be described.

First, the operation of the system 10 in the case where the processing of the schedule for transmitting the counter information collected from the image forming apparatus in the system 10 to the seller system at a specific timing is successfully executed will be described. Hereinafter, the case where the execution of schedules S1, S2, S3, and S4 is started at the same time will be described as an example.

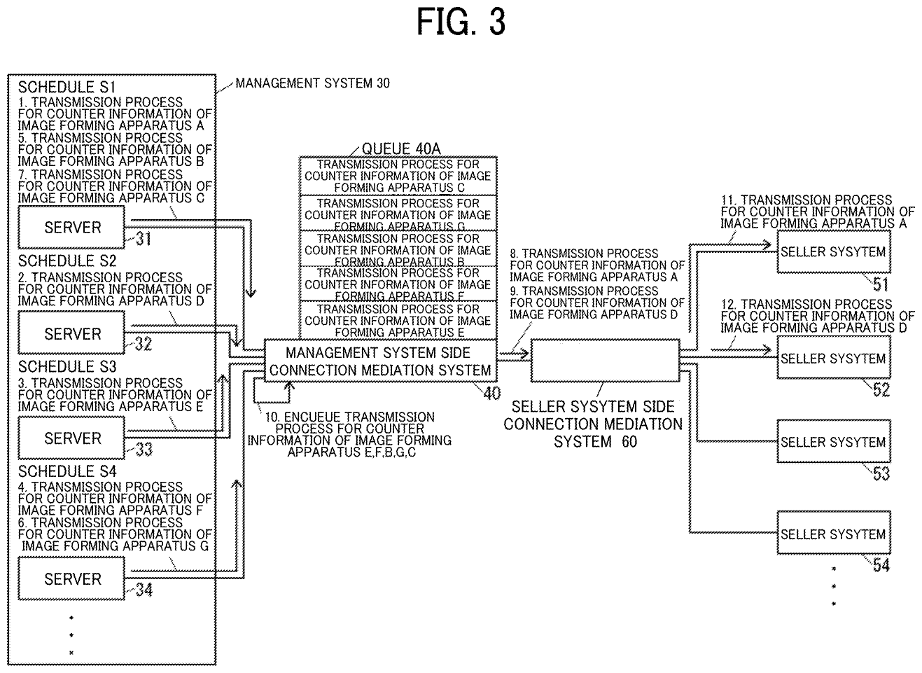

FIG. 3 is a diagram showing a part of an example of the operation of the system 10 in the case where the processing of schedules S1, S2, S3, and S4 is successfully executed.

First, as shown in FIG. 3, the servers 31, 32, 33, and 34 in the management system 30 execute transmission processes for the counter information of the image forming apparatus according to the schedules S1, S2, S3, and S4 stored in the schedule information 35b (1, 2, 3, 4, 5, 6, and 7). That is, the servers 31, 32, 33, and 34 obtain the counter information of the corresponding image forming apparatus from the collection information 35a, set the seller system as the final destination according to the schedules S1, S2, S3, and S4, and transmit the acquired counter information to the management system side connection mediation system 40. Note that the order of the execution of the transmission processes in which the management system 30 transmits the counter information of the image forming apparatus is not particularly determined, and the counter information is transmitted almost in parallel.

When the management system side connection mediation system 40 receives the counter information of the image forming apparatus from the management system 30, the management system side connection mediation system 40 executes the transmission processes for the two pieces of counter information transmitted earlier among the counter information transmitted from the management system 30, based on the fact that the maximum number of parallel processes is two as described above (8 and 9). That is, the management system side connection mediation system 40 transmits the target counter information to the seller system side connection mediation system 60.

The management system side connection mediation system 40 temporarily stores, in the queue 40a, the transmission processes for the counter information other than the two pieces of counter information transmitted earlier among the counter information transmitted from the management system 30 (10).

When the seller system side connection mediation system 60 receives the counter information of the image forming apparatus from the management system side connection mediation system 40, the seller system side connection mediation system 60 executes the transmission process for the counter information transmitted from the management system side connection mediation system 40 (11 and 12). That is, the seller system side connection mediation system 60 transmits the target counter information to the seller system which is set as the final destination of the counter information.

Note that when the seller system successfully receives the counter information transmitted from the seller system side connection mediation system 60, the seller system returns a response indicating that the counter information has been successfully received to the server that has executed the target transmission process among the servers in the management system 30. The response returned from the seller system is received by the destination server in the management system 30 via the seller system side connection mediation system 60 and the management system side connection mediation system 40 in that order.

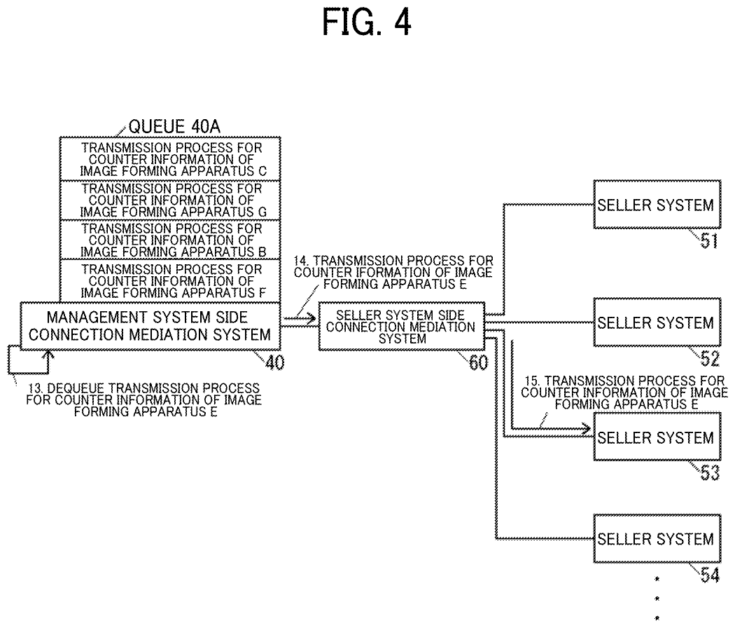

FIG. 4 is a diagram showing an example of an operation subsequent to the operation shown in FIG. 3.

In the case where transmission processes for the counter information are stored in the queue 40a, regarding any one of the transmission processes that has been executed, when the management system side connection mediation system 40 receives a response from the seller system indicating that the counter information has been successfully received, as shown in FIG. 4, the management system side connection mediation system 40 extracts the leading transmission process from the queue 40a among the transmission processes stored in the queue 40a (13), and executes the leading transmission processes (14).

When the seller system side connection mediation system 60 receives the counter information of the image forming apparatus from the management system side connection mediation system 40, the seller system side connection mediation system 60 executes the transmission process for the counter information transmitted from the management system side connection mediation system 40 (15).

Next, the operation of the system 10 in the case where an error occurs during the execution of the schedule processes for transmitting the counter information collected from the image forming apparatus in the system 10 to the seller system at a specific timing will be described. Hereinafter, the case where the execution of the schedules S1, S2, S3, and S4 is started at the same time will be described as an example.

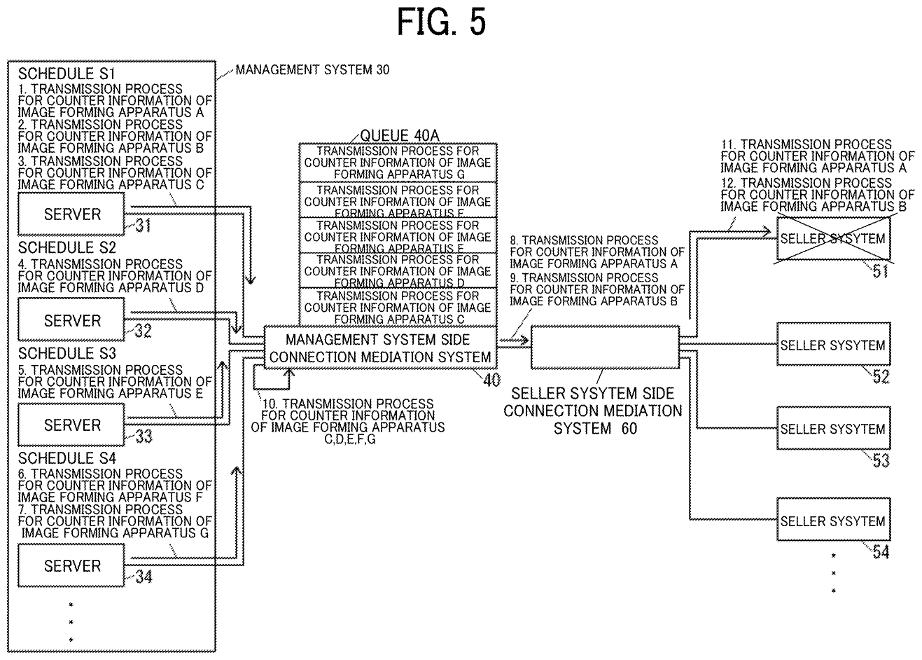

FIG. 5 is a diagram showing an example of the operation of the system 10 in the case where an error occurs during the execution of the processing of the schedules S1, S2, S3, and S4.

First, as shown in FIG. 5, the servers 31, 32, 33, and 34 in the management system 30 execute the transmission processes for the counter information of the image forming apparatus according to the schedule S1, S2, S3, and S4 stored in the schedule information 35b (1, 2, 3, 4, 5, 6, and 7).

When the management system side connection mediation system 40 receives the counter information of the image forming apparatus from the management system 30, the management system side connection mediation system 40 executes the transmission processes for the two pieces of counter information transmitted earlier among the counter information transmitted from the management system 30 (8 and 9).

The management system side connection mediation system 40 temporarily stores in the queue 40a the transmission processes for the counter information other than the two pieces of counter information transmitted earlier among the counter information received from the management system 30 (10).

When the seller system side connection mediation system 60 receives the counter information of the image forming apparatus from the management system side connection mediation system 40, the seller system side connection mediation system 60 executes the transmission process for the counter information transmitted from the management system side connection mediation system 40 (11 and 12).

Here, an error occurs in the seller system 51 due to various causes such as an error due to a sudden load of processing in the seller system 51, based on the counter information of the image forming apparatus A and the counter information of the image forming apparatus B being simultaneously transmitted from the seller system side connection mediation system 60. Here, when such an error occurs, it might be possible that the seller system 51 cannot return the response indicating that the counter information has been successfully received to the server executed the target transmission process among the servers in the management system 30. In addition, it might be possible that the seller system 51 returns a response indicating that the counter information could not be successfully received due to the occurrence of an error to the server executed the target transmission process among the servers in the management system 30.

In the case where the transmission process for the counter information is stored in the queue 40a, regarding any one of the transmission processes that has been executed, when the management system side connection mediation system 40 receives a response from the seller system indicating that the counter information could not be successfully received due to the occurrence of a processing error in the seller system side connection mediation system 60 or the seller system, the management system side connection mediation system 40 extracts the leading transmission process from the queue 40a among the transmission processes stored in the queue 40a, and executes the leading transmission process. Note that the timing at which the seller system returns the response indicating that the counter information could not be successfully received due to the occurrence of the processing error in the seller system side connection mediation system 60 or the seller system is later than the timing at which the seller system returns the response indicating that the counter information has been successfully received. Therefore, when the response indicating that the counter information could not be successfully received due to the occurrence of the processing error in the seller system side connection mediation system 60 or the seller system is returned from the seller system, the execution of the next transmission process by the management system side connection mediation system 40 is delayed as compared with a case where the response indicating that the counter information has been successfully received is returned from the seller system.

When the transmission process for the counter information is stored in the queue 40a, regarding any transmission process that has been executed, it might be possible that the management system side connection mediation system 40 does not receive the response indicating that the counter information has been successfully received or the response indicating that the counter information could not be successfully received due to the occurrence of the processing error in the seller system side connection mediation system 60 or the seller system. At this time, the management system side connection mediation system 40 does not execute the transmission process stored in the queue 40a until the elapsed time exceeds a specific time after the management system side connection mediation system 40 itself executes the transmission process. Therefore, when the response indicating that the counter information has been successfully received, or the response indicating that the counter information could not be successfully received due to the occurrence of the processing error in the seller system side connection mediation system 60 or the seller system has not returned from the seller system, the execution of the next transmission process by the management system side connection mediation system 40 is delayed, compared with the case where the response indicating that the counter information has been successfully received is returned from the seller system.

In the example shown in FIG. 5, occurring the error during the execution of the processing of schedule S1 provides an influence such that the delay occurs not only in the schedule S1 but also in the schedules S2, S3, and S4. That is, in the system 10, when the error occurs during the execution of the processing of the schedules S1, S2, S3, and S4, there is the influence such that the delay occurs not only in the schedule in which the error has occurred but also in the schedules in which the error has not occurred. In addition, when the number of image forming apparatuses to be scheduled is not a few but a large number such as several thousand, for example, the influence of the delay of the schedule becomes very large.

Next, the operation of the system 10 when queuing a schedule in a server in the management system 30 will be described.

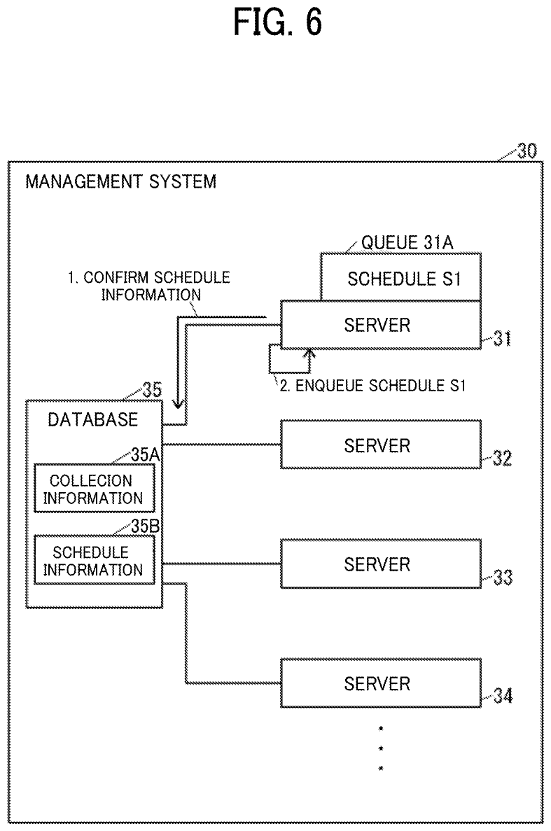

FIG. 6 is a diagram showing an example of the operation of the system 10 when queuing a schedule in a server in the management system 30.

As shown in FIG. 6, the server in the management system 30 confirms whether the number of schedules being executed is equal to or less than a specific number by using the schedule information 35b, before executing the transmission process for the counter information of the image forming apparatus, according to the target schedule stored in the schedule information 35b (1).

When the server in the management system 30 confirms that the number of schedules being executed is not equal to or less than the specific number, the server queues the target schedule (2). On the other hand, when the server in the management system 30 confirms that the number of schedules being executed is equal to or less than the specific number, the server executes the transmission process for the counter information of the image forming apparatus according to the target schedule.

Next, the operation of the system 10 when dequeuing a schedule from a server in the management system 30 will be described.

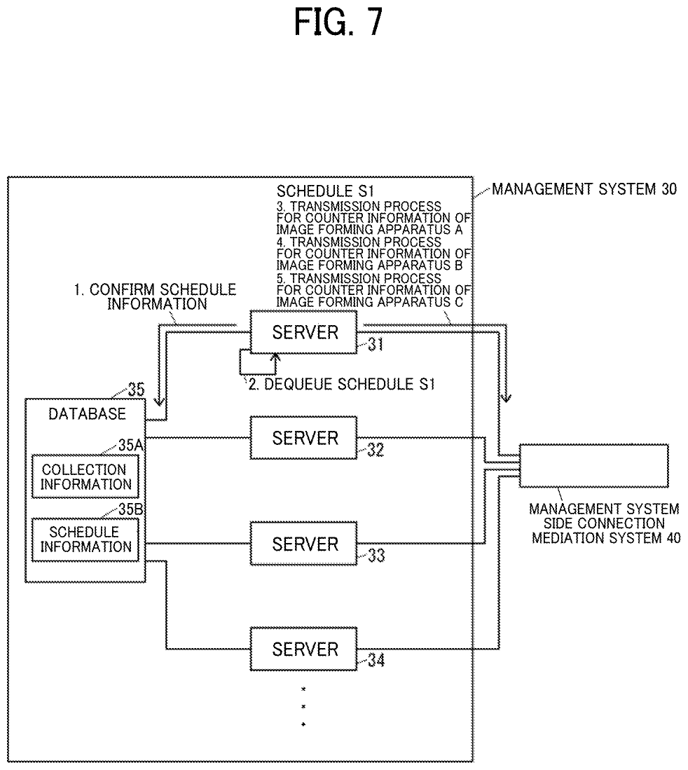

FIG. 7 is a diagram showing an example of the operation of the system 10 when dequeuing a schedule from a server in the management system 30.

When a schedule is stored in the queue of the server's own, the server in the management system 30 confirms whether the number of schedules being executed is equal to or less than a specific number, by using the schedule information 35b, as shown in FIG. 7 (1).

When the server in the management system 30 confirms that the number of schedules being executed is equal to or less than the specific number, the server dequeues the leading schedule stored in the queue of the server's own (2), and executes the transmission process for the counter information of the image forming apparatus in accordance with the schedule (3, 4, and 5).

As explained above, the management system 30 can temporarily queue a schedule that has a large adverse effect on the transmission efficiency of the counter information collected from the image forming apparatus, and dequeue a schedule that has a reduced adverse effect on the transmission efficiency of the counter information collected from the image forming apparatus, and execute the schedule. Therefore, the management system 30 can efficiently transmit the counter information collected from the image forming apparatus.

Since the condition based on the number of schedules being executed is the enqueue condition, the management system 30 can temporarily queue the schedule when the number of the schedules being executed is large. Therefore, the management system 30 can suppress the occurrence of the situation that the transmission efficiency of the counter information deteriorates due to the large number of schedules executed in parallel.

Since the condition based on the number of schedules being executed is the dequeue condition, the management system 30 can dequeue the schedule and execute the schedule when the number of the schedules being executed is small. Therefore, the management system 30 can suppress the occurrence of the situation that the transmission efficiency of the counter information deteriorates due to the large number of schedules executed in parallel.

### Second Embodiment

First, the configuration of a system according to a second embodiment of the present disclosure will be described.

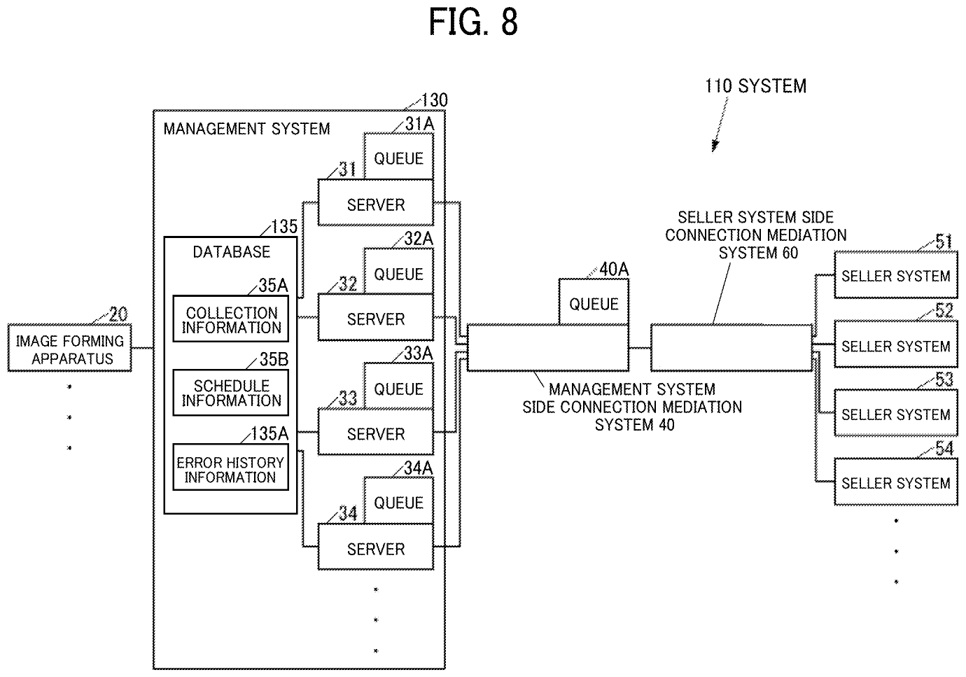

FIG. 8 is a block diagram of a system 110 according to the present embodiment.

As shown in FIG. 8, the configuration of the system 110 is the same as that of the system 10 according to the first embodiment (refer to FIG. 1) in which a management system 130 is provided instead of the management system 30 (refer to FIG. 1).

The configuration of the management system 130 is the same as the configuration in which the management system 30 includes a database 135 instead of the database 35 (refer to FIG. 1).

The configuration of the database 135 is the same as the configuration in which the database 35 includes error history information 135a indicating an execution error history of a schedule by the server in the management system 130.

Next, the operation of the system 110 will be described.

The operation of the system 110 is the same as the operation of the system 110, except for the points described below.

First, the operation of the system 110 when the execution error history of a schedule by the server in the management system 130 is stored in the error history information 135a will be described.

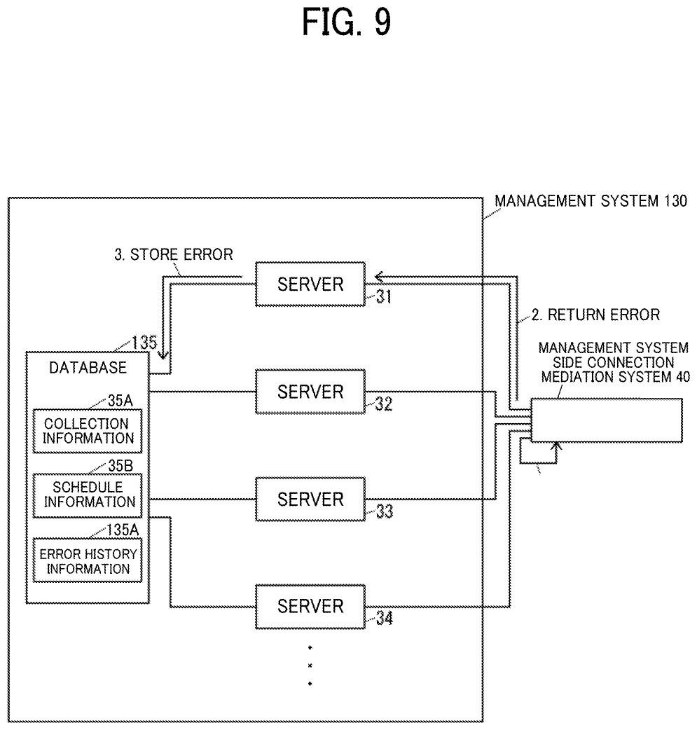

FIG. 9 is a diagram showing an example of the operation of the system 110 when the execution error history of a schedule by the server in the management system 130 is stored in the error history information 135a.

As shown in FIG. 9, when the management system side connection mediation system 40 detects one of the following errors (i) and (ii) (1), the management system side connection mediation system 40 returns the detected error to the server that executed the target transmission process among the servers in the management system 130 (2):

(i) regarding the executed transmission process, an error that the seller system has returned a response indicating that the counter information could not be successfully received due to the occurrence of a processing error in the seller system side connection mediation system 60 or the seller system; and

(ii) regarding the executed transmission process, an error that the seller system has not returned a response indicating that the counter information is successfully received, or that the seller system has not returned a response indicating that the counter information could not be successfully received due to the occurrence of a processing error in the seller system side connection mediation system 60 or the seller system even though the time elapsed since the management system side connection mediation system 40 itself executed the transmission process exceeds a specific time.

When the server in the management system 130 receives an error from the management system side connection mediation system 40, the server in the management system 130 stores the returned error in the error history information 135a (3).

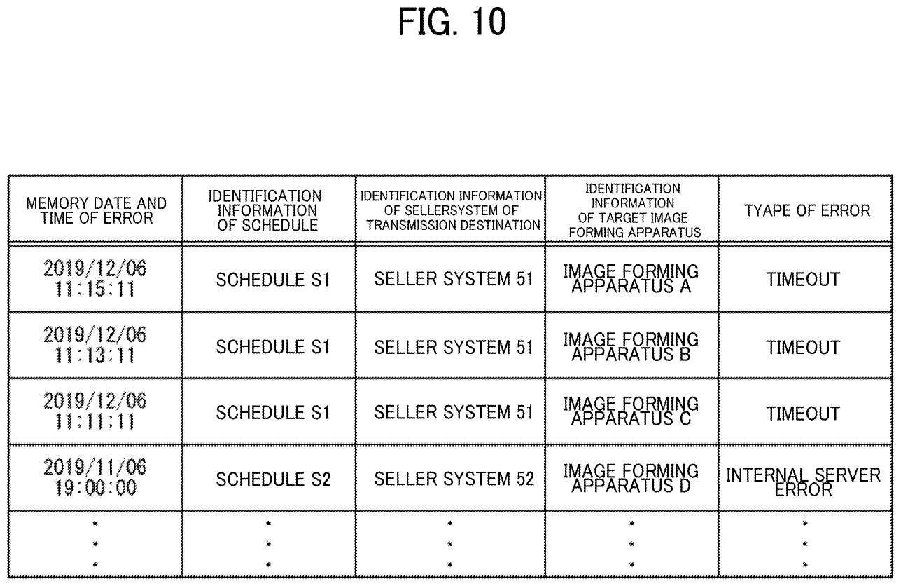

FIG. 10 is a diagram showing an example of the error history information 135a.

The error history information 135a shown in FIG. 10 shows the memory date and time of error, the identification information of the schedule of the error target, the identification information of the seller system to which the counter information is transmitted in the schedule of the error target, the identification information of the target image forming apparatus of the counter information in the schedule of the error target, and the type of the error, for each error. Here, in the type of the error, “Timeout” indicates, regarding the executed transmission process, an error that the seller system has not returned a response indicating that the counter information is successfully received, or a response indicating that the counter information could not be successfully received due to a processing error in the seller system side connection mediation system 60 or the seller system, even though the time elapsed since the management system side connection mediation system 40 itself executed the transmission process exceeds the specific time. Further, “Internal Server Error” indicates, regarding the executed transmission process, an error that the seller system has returned the response indicating that the counter information could not be successfully received due to the occurrence of the processing error in the seller system side connection mediation system 60 or the seller system.

Next, the operation of the system 110 when queuing a schedule in the server in the management system 130 will be described.

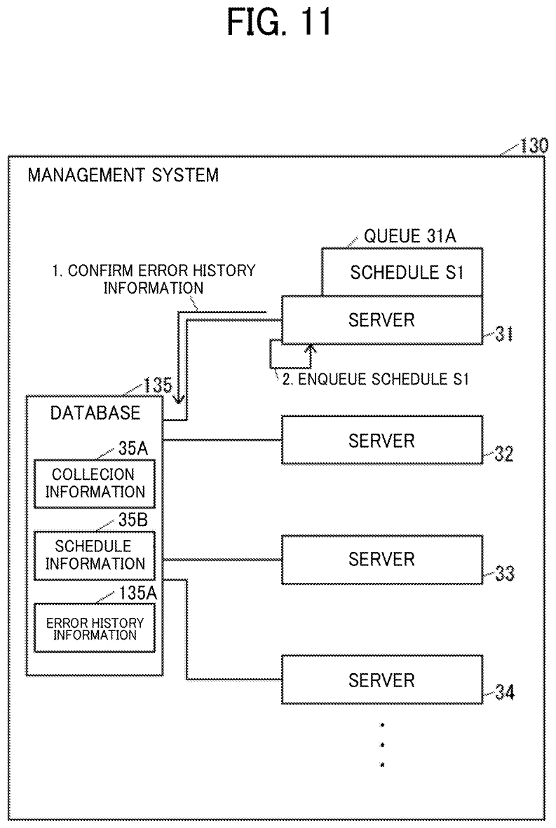

FIG. 11 is a diagram showing an example of the operation of the system 110 when queuing a schedule in the server in the management system 130.

When the server in the management system 130 stores the error in the error history information 135a as shown in FIG. 9, the server confirms, based on the error history information 135a, whether the error history satisfies a specific condition regarding the seller system to which the counter information is transmitted in the schedule of the error target, as shown in FIG. 11 (1). Here, the specific condition means that the occurrence situation of an error in a specific period satisfies a specific situation. The specific period is, for example, a period from the current time to a specific time before such as 30 minutes before. In addition, the specific situation is set by each type of error such as a situation in which “Timeout” error has occurred twice or more in succession.

When the server in the management system 130 confirms that the error history satisfies the specific condition with respect to the seller system to which the counter information is transmitted in the schedule of the error target, the server queues the schedule (2), and then ends the processing of the schedule.

Next, the operation of the system 110 when dequeuing a schedule from the server in the management system 130 will be described.

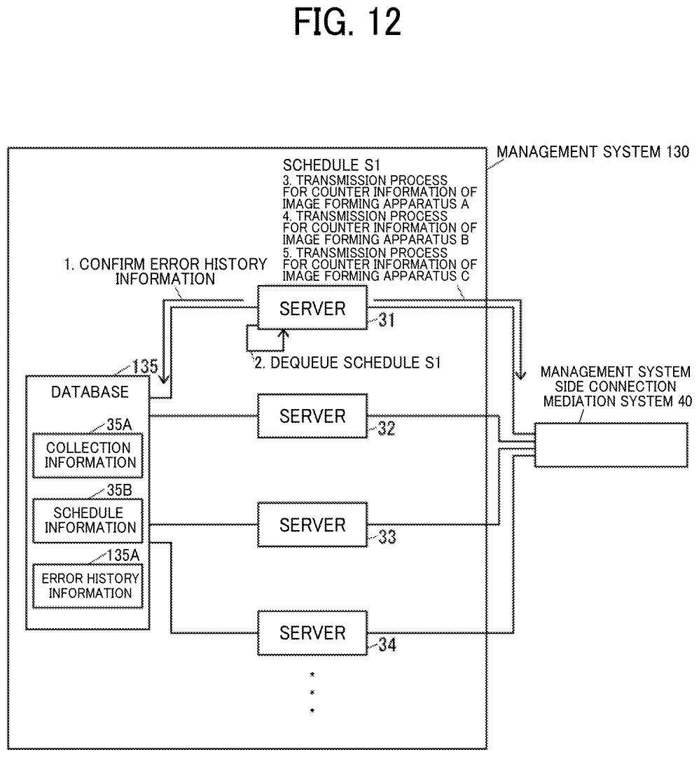

FIG. 12 is a diagram showing an example of the operation of the system 110 when dequeuing a schedule from the server in the management system 130.

When a schedule is stored in the queue of the server's own, as shown in FIG. 12, the server in the management system 130 confirms whether the error history satisfies the specific condition by using the error history information 135a with respect to the seller system to which the counter information is transmitted in the schedule stored in the queue of the server's own (1). Here, the specific condition is a condition that no error occurs within a specific period. Note that the specific period is, for example, a period from the current time to a specific time before such as 30 minutes before.

When the server in the management system 130 confirms that the error history satisfies the specific condition regarding the seller system to which the counter information is transmitted in the schedule stored in the queue of the server's own, the server in the management system 130 dequeues the schedule (2), and executes the transmission process for the counter information of the image forming apparatus according to the schedule (3, 4, and 5).

As described above, since the condition based on the past error in transmission of the information to the transmission destination of the counter information in the schedule is the enqueue condition, the management system 130 can temporarily queue the schedule when there is a high possibility that the transmission error of the counter information to the transmission destination is large. Therefore, the management system 130 can suppress the occurrence of the situation that the transmission efficiency of the counter information deteriorates because the counter information is transmitted to the transmission destination where the error occurs.

Since the condition based on the past error in transmission of the information to the transmission destination of the counter information in the schedule is the dequeue condition, the management system 130 can dequeue and execute the schedule when there is a high possibility that the transmission error of the counter information to the transmission destination is low. Therefore, the management system 130 can suppress the occurrence of the situation that the transmission efficiency of the counter information deteriorates because the counter information is transmitted to the transmission destination where the error occurs.

It should be noted that FIG. 12 shows a case where a schedule is dequeued from the server in the management system 130. However, the server in the management system 130 may also confirm the error history information 135a before executing the schedule, instead of when dequeuing the schedule from the server itself.

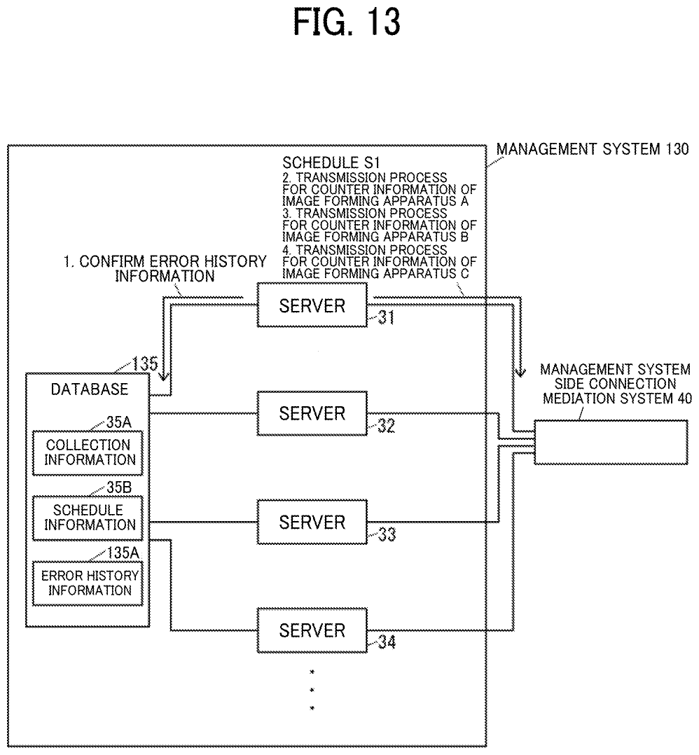

FIG. 13 is a diagram showing an example of the operation of the system 110 when the server in the management system 130 executes the schedule after confirming the error history information 135a.

When executing the schedule, the server in the management system 130 confirms by using the error history information 135a whether the error history satisfies a specific condition with respect to the seller system to which the counter information is transmitted in the schedule as shown in FIG. 13 (1). Here, the specific condition is a condition that no error occurs within a specific period. Note that the specific period is, for example, a period from the current time to a specific time before such as 30 minutes before.

When the server in the management system 130 confirms that the error history satisfies the specific condition regarding the seller system to which the counter information is transmitted in the schedule to be executed, the server executes the transmission process for the counter information of the image forming apparatus in accordance with the schedule (2, 3, and 4). On the other hand, when the server in the management system 130 confirms that the error history does not satisfy the specific condition regarding the seller system to which the counter information is transmitted in the schedule to be executed, the server in the management system 130 queues the schedule.

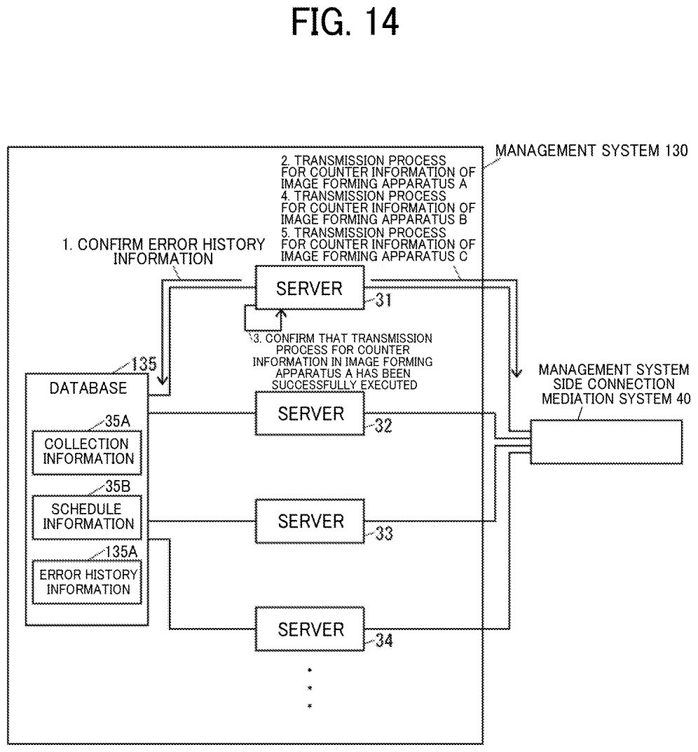

Further, when the server in the management system 130 executes the schedule after confirming the error history information 135a, as shown in FIG. 14, the server may confirm that the error history satisfies the specific condition with respect to the seller system to which the counter information is transmitted in the schedule to be executed (1), and then execute firstly only the transmission process for the counter information of any one of the image forming apparatuses in the schedule in executing the schedule (2). Further, in the case where the server in the management system 130 confirms that the transmission process for the counter information in the schedule has been successfully executed based on the response returned from the seller system (3), when a transmission process that has not been executed in the schedule remains, the server executes the transmission process for the counter information of all the remaining image forming apparatuses in the schedule in parallel (4 and 5). On the other hand, when an error is detected in the transmission process for the counter information in the schedule, the server in the management system 130 queues the schedule. Since the management system 130 executes firstly only the transmission process for the counter information of any one of the image forming apparatuses in the schedule, even if an error occurs, the influence of the error can be minimized.

The system 110 may employ the operation described in the first embodiment instead of the operation described in the present embodiment as the operation when queuing a schedule in the server.

The system 110 may employ the operation described in the first embodiment instead of the operation described in the present embodiment as the operation when dequeuing a schedule from the server.

### Third Embodiment

First, the configuration of a system according to a third embodiment of the present disclosure will be described.

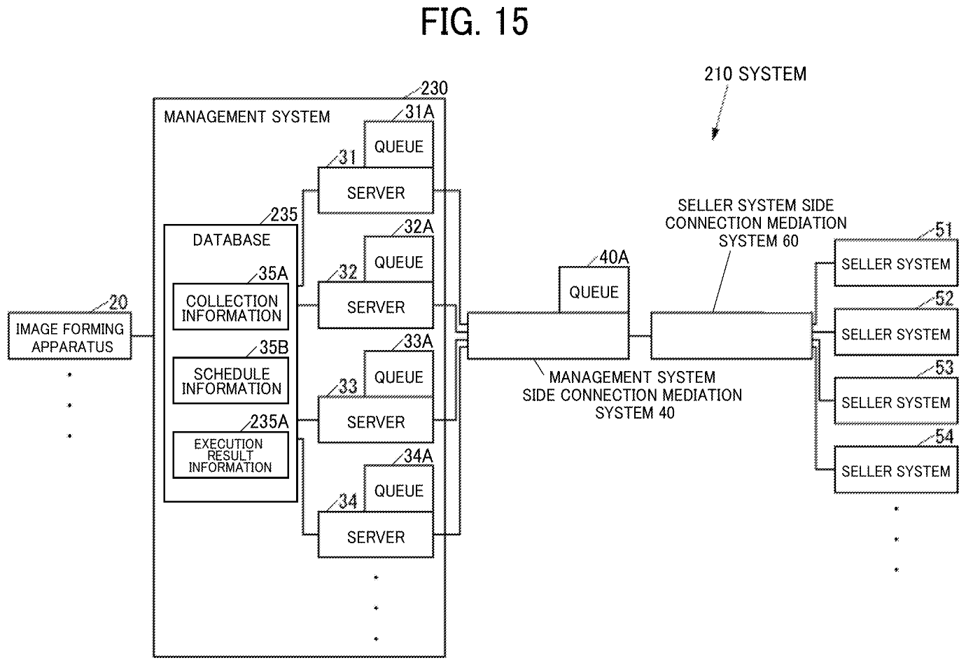

FIG. 15 is a block diagram of a system 210 according to the present embodiment.

As shown in FIG. 15, the configuration of the system 210 is the same as that of the system 110 (refer to FIG. 8) according to the second embodiment, in which a management system 230 is provided instead of the management system 130 (refer to FIG. 8).

The configuration of the management system 230 is the same as the configuration in which the management system 130 includes a database 235 instead of the database 135 (refer to FIG. 8).

The configuration of the database 235 is the same as the configuration in which the database 135 includes execution result information 235a indicating the execution result of a schedule by the server in the management system 230 instead of the error history information 135a (refer to FIG. 8).

Next, the operation of the system 210 will be described.

The operation of the system 210 is the same as the operation of the system 110, except for the points described below.

First, the operation of the system 210 when the execution result of a schedule by the server in the management system 230 is stored in the execution result information 235a will be described.

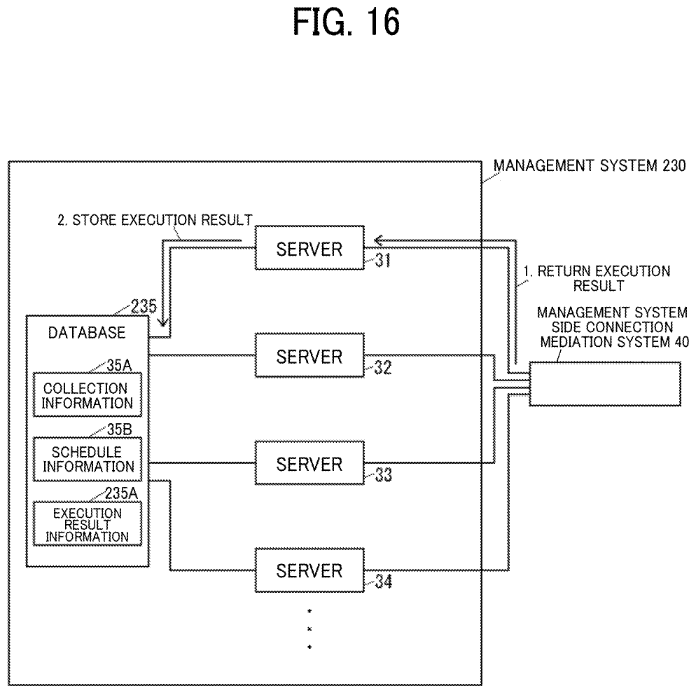

FIG. 16 is a diagram showing an example of the operation of the system 210 when the execution result of a schedule by the server in the management system 230 is stored in the execution result information 235a.

As shown in FIG. 16, the management system side connection mediation system 40 returns the execution result of the transmission process to the server that executed the target transmission process among the servers in the management system 230 regarding the executed transmission process (1). Here, the execution result may be a response indicating that the counter information from the seller system has been successfully received, or may be an error as shown in FIG. 9.

When the server in the management system 230 receives the execution result from the management system side connection mediation system 40, the server stores the returned execution result in the execution result information 235a (2).

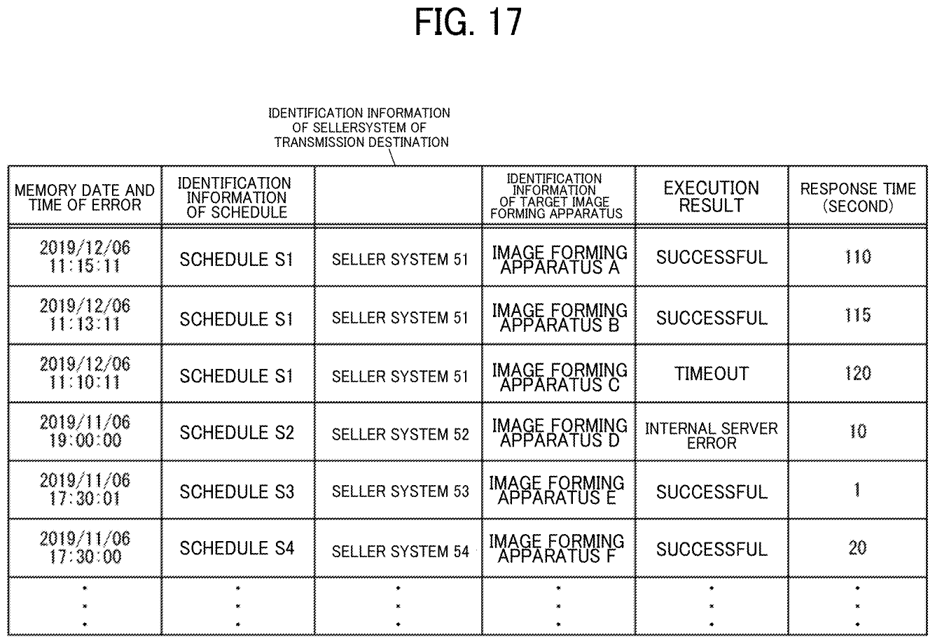

FIG. 17 is a diagram showing an example of the execution result information 235a.

The execution result information 235a shown in FIG. 17 indicates the memory date and time of the execution result, identification information of the target schedule of the execution result, identification information of the seller system to which the counter information is transmitted in the target schedule of the execution result, identification information of the image forming apparatus that is the target of the counter information in the target schedule of the execution result, the type of the execution result, and the response time of the transmission process in the target schedule of the execution result, for each transmission process. In the type of the execution result, “Successful” indicates that the response indicating that the counter information has been successfully received has been returned from the seller system regarding the executed transmission process. Furthermore, the response time is the time until the server in the management system 230 receives the execution result from the management system side connection mediation system 40 after the server in the management system 230 transmits the counter information of the target image forming apparatus to the management system side connection mediation system 40, regarding the transmission process.

Next, the operation of the system 210 when queuing a schedule in the server in the management system 230 will be described.

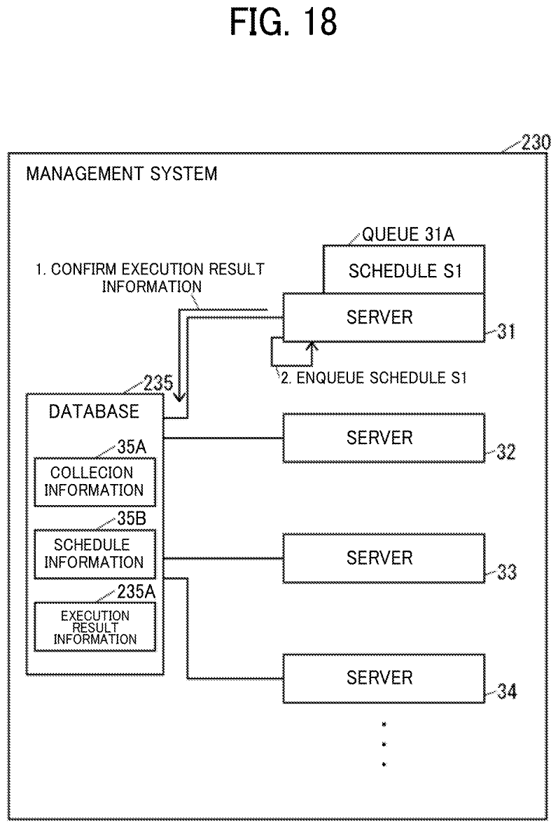

FIG. 18 is a diagram showing an example of the operation of the system 210 when queuing a schedule in the server in the management system 230.

When the server in the management system 230 stores an execution result in the execution result information 235a as shown in FIG. 16, the server confirms whether the execution result satisfies a specific condition based on the execution result information 235a, regarding the seller system to which the counter information is transmitted in the target schedule of the execution result, as shown in FIG. 18 (1). Here, the specific condition is to satisfy any of a first condition that an error occurrence condition within a specific period satisfies a specific situation, and a second condition that the response time when the transmission process for the counter information is successful takes a specific time such as thirty (30) seconds or more, within the specific period, as explained in the second embodiment. Here, the specific period is, for example, a period from the current time to a specific time before such as thirty (30) minutes before. The second condition may be a condition that the response time when the transmission process for the counter information is successful takes the specific time or more even once within the specific period. The second condition may further be a condition that the average response time within the specific period when the transmission process for the counter information is successful takes the specific time or more. The second condition may further include a condition that a specific number, for example, fifty (50) or more of image forming apparatuses that have not successfully transmitted the counter information in the target schedule remain.

When the server in the management system 230 confirms that the execution result satisfies the specific condition with respect to the seller system to which the counter information is transmitted in the target schedule of the execution result, the server in the management system 230 queues the schedule (2), and then ends the processing of the schedule.

Next, the operation of the system 210 when dequeuing a schedule from the server in the management system 230 will be described.

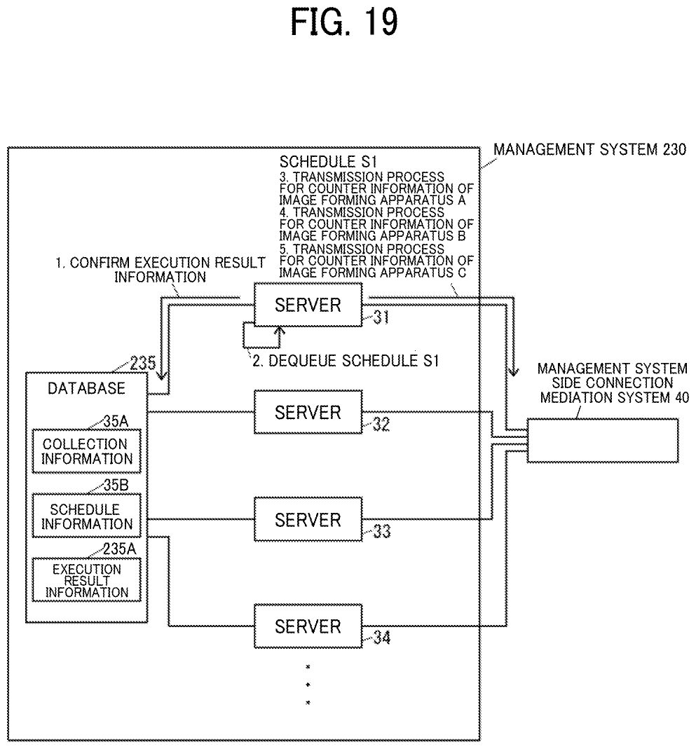

FIG. 19 is a diagram showing an example of the operation of the system 210 when dequeuing a schedule from the server in the management system 230.

When a schedule is stored in the queue of the server's own, the server in the management system 230 confirms whether the execution result satisfies a specific condition based on the execution result information 235a, regarding the seller system to which the counter information is transmitted in the schedule stored in the queue of the server's own, as shown in FIG. 19 (1). Here, the specific condition is to satisfy both a first condition that no error has occurred within a specific period and a second condition that the response time when the transmission process for the counter information is successful does not take more than a specific time such as 30 seconds within the specific period. Note that the specific period is, for example, a period from the current time to a specific time before, such as 30 minutes before. The second condition may be a condition that the response time when the transmission process for the counter information is successful does not take more than the specific time within the specific period even once. Furthermore, the second condition may be a condition that the average response time within the specific period when the transmission process for the counter information is successful does not take more than the specific time.

When the server in the management system 230 confirms that the execution result satisfies the specific condition regarding the seller system to which the counter information is transmitted in the schedule stored in the queue of the server's own, the server dequeues the schedule (2), and executes the transmission process for the counter information of the image forming apparatus according to the schedule (3, 4, and 5).

As explained above, since the condition based on the past response time of the transmission of the counter information to the transmission destination of the counter information in the schedule is the enqueue condition, the management system 230 can temporarily queue the schedule when the response period is likely to be long. Therefore, the management system 230 can suppress the occurrence of the situation that the transmission efficiency of the information deteriorates because the counter information is transmitted to a transmission destination which requires a long response time.

Since the condition based on the past response time of the transmission of the counter information to the transmission destination of the counter information in the schedule is the dequeue condition, the management system 230 can dequeue and execute the schedule when it is likely that the response time is short. Therefore, the management system 230 can suppress the occurrence of the situation that the transmission efficiency of the information deteriorates because the counter information is transmitted to the transmission destination which requires the long response time.

Note that FIG. 19 shows a case where a schedule is dequeued from the server in the management system 230. However, the server in the management system 230 may confirm the execution result information 235a before executing the schedule, without being limited to the case when dequeuing the schedule from the server itself.

Further, when the server in the management system 230 confirms the execution result information 235a and then executes the schedule, as in the operation shown in FIG. 14, the server may execute firstly only the transmission process for the counter information of any one of the image forming apparatuses in the schedule.

The system 210 may employ the operation described in the first embodiment or the second embodiment in place of the operation described in the present embodiment as the operation when queuing a schedule in the server.

The system 210 may employ the operation described in the first embodiment or the second embodiment in place of the operation described in the present embodiment as the operation when dequeuing a schedule from the server.

### Fourth Embodiment

First, the configuration of a system according to a fourth embodiment of the present disclosure will be described.

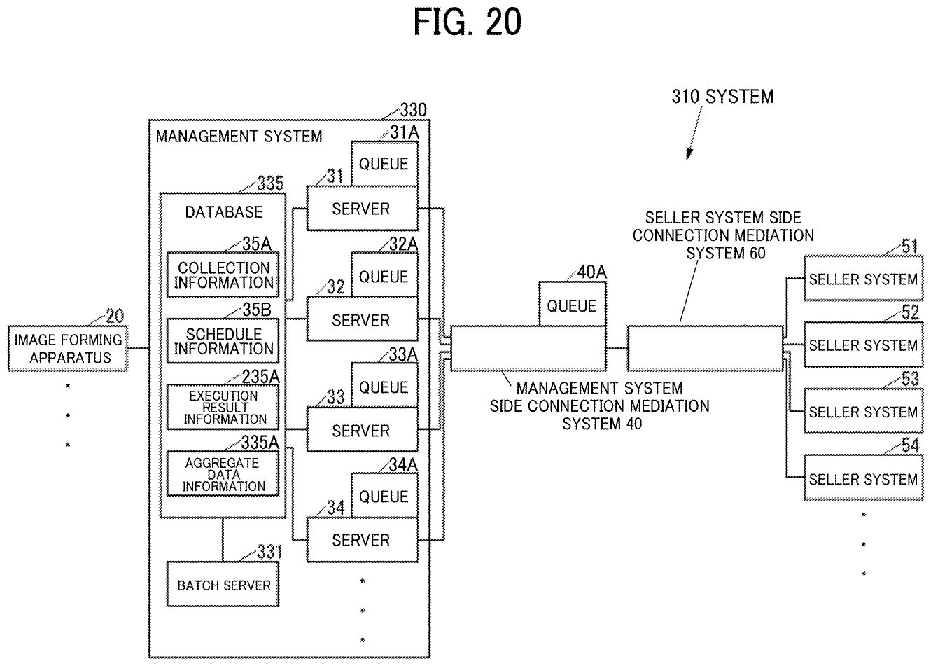

FIG. 20 is a block diagram of a system 310 according to the present embodiment.

As shown in FIG. 20, the configuration of the system 310 is the same as that of the system 210 (refer to FIG. 15) according to the third embodiment, in which a management system 330 is provided instead of the management system 230 (refer to FIG. 15).

The configuration of the management system 330 is the same as the configuration in which the management system 230 includes a batch server 331 that executes batch processing, and a database 335 instead of the database 235 (see FIG. 15).

The configuration of the database 335 is the same as the configuration in which the database 235 includes aggregate data information 335a indicating aggregate data of an execution result.

Next, the operation of the system 310 will be described.

The operation of the system 310 is the same as the operation of the system 210, except for the points described below.

First, the operation of the system 310 in the case where the aggregate data of the execution result of a schedule by the server in the management system 330 is stored in the aggregate data information 335a will be described.

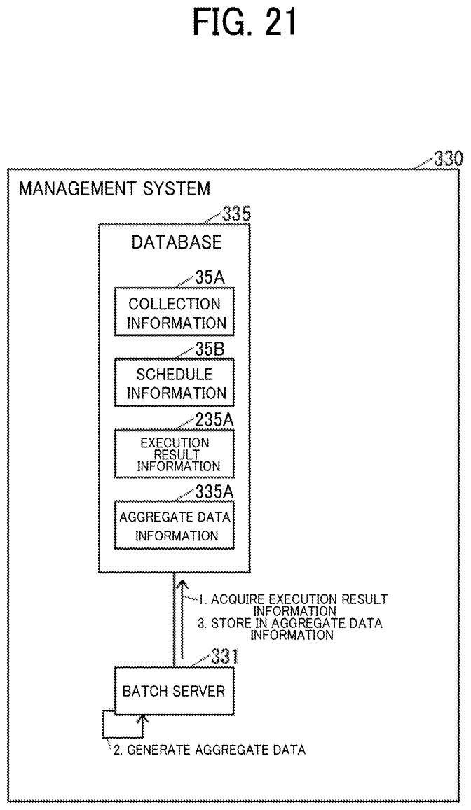

FIG. 21 is a diagram showing an example of the operation of the system 310 in the case where the aggregate data of the execution result of a schedule by the server in the management system 330 is stored in the aggregate data information 335a.

The batch server 331 acquires the execution result information 235a from the database 335, periodically, for example, once every hour as shown in FIG. 21.

When the batch server 331 acquires the execution result information 235a from the database 335, the batch server 331 generates aggregate data based on the execution result information 235a (2). Here, the batch server 331 generates the aggregate data related to an execution result which includes the memory date and time in a specific aggregate period, for example, one hour after the previous aggregate period, among the execution results shown in the execution result information 235a.

When the batch server 331 generates the aggregate data, the batch server 331 stores the generated aggregate data in the aggregate data information 335a (3).

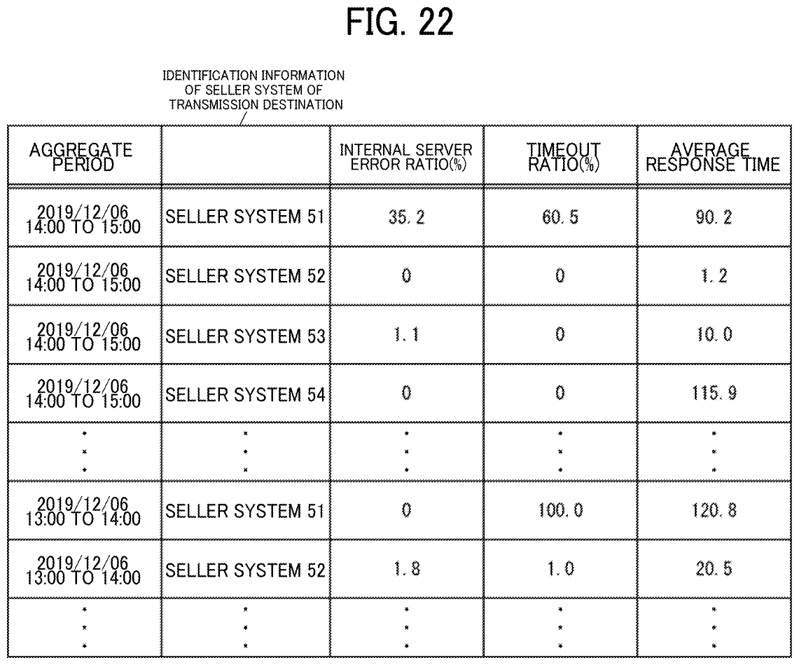

FIG. 22 is a diagram showing an example of the aggregate data information 335a.

The aggregate data information 335a shown in FIG. 22 indicates an aggregate period of the execution result, identification information of the seller system to which the counter information is transmitted in the target schedule of the execution result, a ratio of “Internal Server Error” in the aggregate period, a ratio of “Timeout” in the aggregate period, and an average response time in the aggregate period.

Next, the operation of the system 310 when queuing a schedule in the server in the management system 330 will be described.

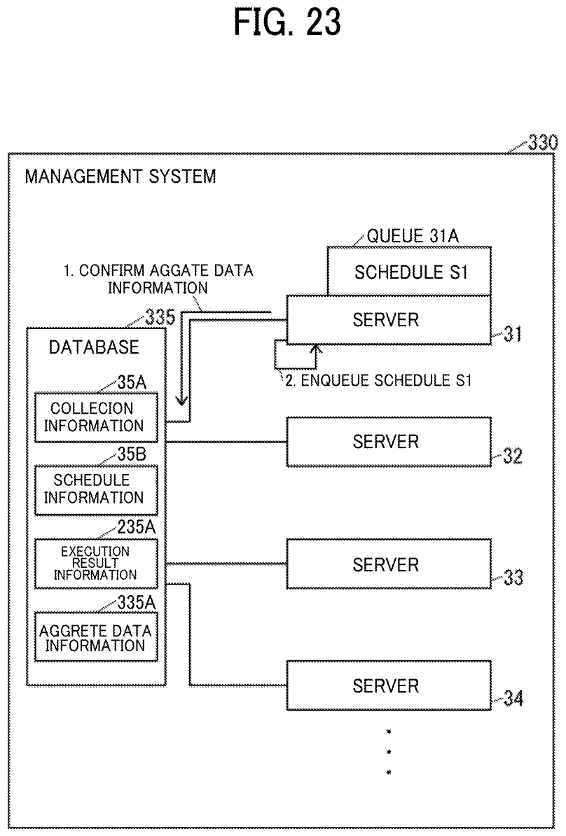

FIG. 23 is a diagram showing an example of the operation of the system 310 when queuing a schedule in the server in the management system 330.

The server in the management system 330 confirms whether the current time period is a time period suitable for executing the schedule by using the aggregate data information 335a, according to the target schedule stored in the schedule information 35b, as shown in FIG. 21, before executing the transmission process for the counter information of the image forming apparatus (1). Here, the time period suitable for executing the schedule is a time period in which the ratio of “Internal Server Error”, the ratio of “Timeout” in the aggregate period, and the average response time in the aggregate period is respectively equal to or less than the respective specific threshold value. For example, the server in the management system 330 determines that the current time period is the time period suitable for executing the schedule when the time period one week ago corresponding to the current time period is the time period suitable for executing the schedule.

When the server in the management system 330 confirms that the current time period is not the time period suitable for executing the schedule, the server queues the target schedule (2). On the other hand, when the server in the management system 330 confirms that the current time period is the time period suitable for executing the schedule, the server executes the transmission process for the counter information of the image forming apparatus according to the target schedule.

Next, the operation of the system 310 when dequeuing a schedule from the server in the management system 330 will be described.

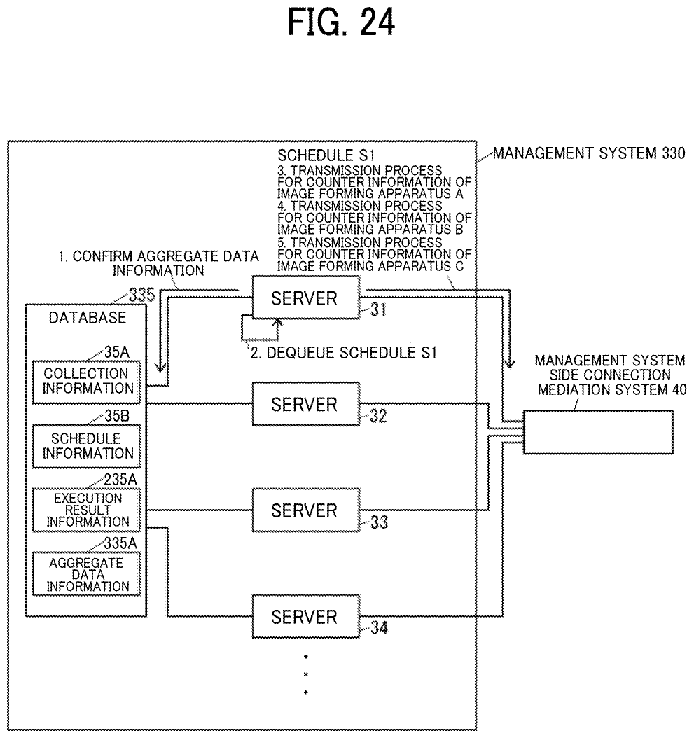

FIG. 24 is a diagram showing an example of the operation of the system 310 when dequeuing a schedule from the server in the management system 330.

When a schedule is stored in the queue of the server's own, the server in the management system 330 confirms whether the current time period is the time period suitable for executing the schedule by the aggregate data information 335a, as shown in FIG. 24 (1).

When the server in the management system 330 confirms that the current time period is the time period suitable for executing the schedule, the server dequeues the leading schedule stored in the server itself (2), and executes the transmission process for the counter information of the image forming apparatus in accordance with the schedule (3, 4, and 5).

Note that, when queuing the schedule, the server in the management system 330 may confirm the time period suitable for executing the schedule by the aggregate data information 335a, set visibility timeout in the schedule so that the schedule is visualized in the confirmed time period, and queue it. The queued schedule is not visible until the timeout time of the visibility timeout. Therefore, when the schedule in the queue becomes visible, the server in the management system 330 may dequeue the schedule, and execute the transmission process for the counter information of the image forming apparatus according to the schedule. By doing so, when the schedule is stored in the queue of the server's own, the server in the management system 330 does not need to continue to confirm whether the current time period is the time period suitable for executing the schedule.

As described above, the condition based on the aggregate data for each time period of the past execution result of the transmission of the counter information to the transmission destination of the counter information in the schedule is the enqueue condition. Therefore, the management system 330 can temporarily queue the schedule during a time period that is likely not suitable for executing the schedule. Accordingly, the management system 330 can suppress the occurrence of the situation that the transmission efficiency of the counter information deteriorates because a schedule is executed in a time period that is not suitable for executing the schedule.

The condition based on the aggregate data for each time period of the past execution result of the transmission of the counter information to the transmission destination of the counter information in the schedule is the dequeue condition. Therefore, the management system 330 can dequeue a schedule during a time period that is likely to be suitable for executing the schedule, and execute the schedule. Accordingly, the management system 330 can suppress the occurrence of the situation that the transmission efficiency of the counter information deteriorates because a schedule is executed in a time period that is not suitable for executing the schedule.

The system 310 may employ the operation described in the first embodiment, the second embodiment, or the third embodiment, instead of the operation described in the present embodiment, as the operation when queuing a schedule in the server.

The system 310 may employ the operation described in the first embodiment, the second embodiment, or the third embodiment instead of the operation described in the present embodiment, as the operation when dequeuing a schedule from the server.

The management system 330 includes the batch server 331 according to the present embodiment. However, the management system 330 does not necessarily need to include the batch server 331 and may cause any server such as the server 31 to perform the function of the batch server 331.

### Fifth Embodiment

First, the configuration of a system according to a fifth embodiment of the present disclosure will be described.

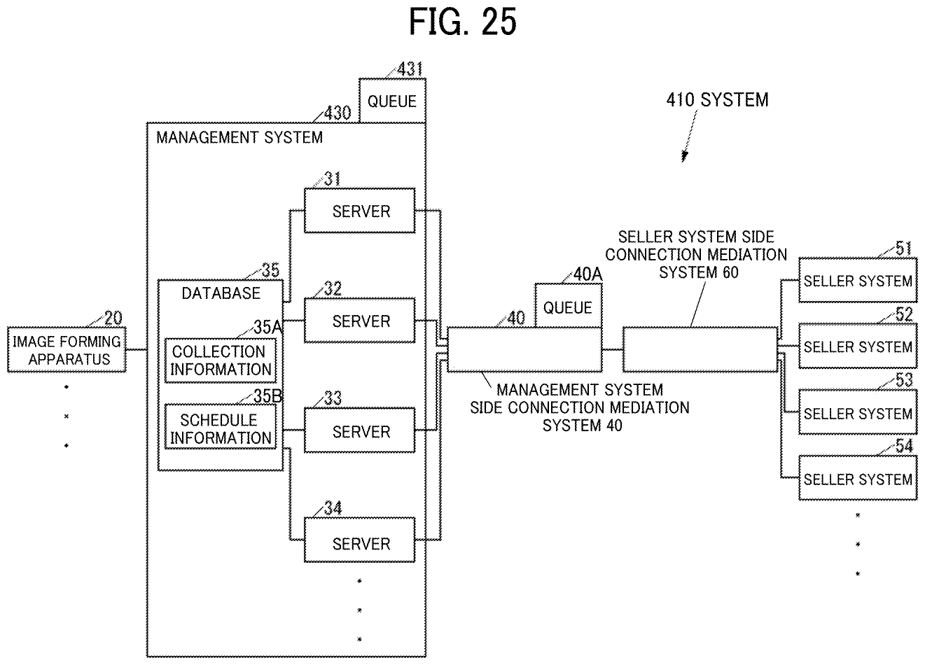

FIG. 25 is a block diagram of a system 410 according to the present embodiment.

As shown in FIG. 25, the configuration of the system 410 is the same as that of the system 10 according to the first embodiment (refer to FIG. 1) in which a management system 430 is provided in place of the management system 30 (refer to FIG. 1).

The configuration of the management system 430 is the same as the configuration in which each of the servers in the management system 30 includes no queue, and the management system 30 includes a queue 431 common to the servers.

Next, the operation of the system 410 will be described.

The operation of the system 410 is the same as the operation of the system 10, except for the points described below.

When the server in the management system 430 queues a schedule, the server stores the schedule in the queue 431 common to all servers, not the queue of the server's own.

Further, when the server in the management system 430 extracts a schedule from the queue 431, the server can extract an arbitrary schedule from the queue 431. For example, the servers 32, 33, and 34 can extract the schedule S1 that is not originally targeted from the queue 431, and then execute the transmission process for the counter information of the image forming apparatus according to the schedule S1.

As described above, the queue 431 is shared by the plurality of servers. Therefore, even if a problem such as a server that has been scheduled in the queue 431 goes down occurs, the management system 430 can dequeue the schedule to be originally executed by the server in which the problem has occurred, from the queue 431 by a server in which the problem has not occurred, and then execute the schedule. Accordingly, if a problem such as any server down occurs, the management system 430 can reduce the possibility that the schedule to be originally executed by the server in which the problem has occurred is not executed.

The management system 430 is obtained by applying the queue 431 common to the servers to the management system 30 according to the first embodiment. The queue 431 common to the servers can be also applied to the management system 130 according to the second embodiment, the management system 230 according to the third embodiment, and the management system 330 according to the fourth embodiment.

Although the electronic apparatus of the present disclosure is the image forming apparatus in each of the embodiments described above, the electronic apparatus of the present disclosure may be an electronic apparatus other than the image forming apparatus such as a personal computer (PC).

What is claimed is:

1. A management system comprising:
a server configured to execute a schedule for transmitting information collected from an electronic device,
wherein the server subjects the schedule to a queuing when an enqueue condition for subjecting the schedule to the queuing is satisfied, and
wherein the server subjects the schedule to a dequeuing to execute the schedule when a dequeue condition for subjecting the schedule to the dequeuing is satisfied.

2. The management system according to claim 1, wherein at least one of the enqueue condition and the dequeue condition includes a condition based on a number of the schedules being executed.

3. The management system according to claim 1, wherein at least one of the enqueue condition and the dequeue condition includes a condition based on a past error in transmission of the information to a transmission destination of the information in the schedule.

4. The management system according to claim 1, wherein at least one of the enqueue condition and the dequeue condition includes a condition based on a past response time in transmission of the information to a transmission destination of the information in the schedule.

5. The management system according to claim 1, wherein at least one of the enqueue condition and the dequeue condition includes a condition based on aggregate data for each time period of a past execution result in transmission of the information to a transmission destination of the information in the schedule.

6. The management system according to claim 1,
wherein the management system comprises a plurality of the servers,
wherein the queuing is shared by the plurality of the servers.
